(19) United States
(12) Patent Application Publication
(10) Pub. No.: US 2017/0103271 A1
(43) Pub. Date: Apr. 13, 2017

(54) DRIVING ASSISTANCE SYSTEM AND DRIVING ASSISTANCE METHOD FOR VEHICLE

(71) Applicant: Mitsubishi Electric Corporation, Tokyo (JP)

(72) Inventor: Tomoya KAWAGOE, Tokyo (JP)

(73) Assignee: Mitsubishi Electric Corporation, Tokyo (JP)

(21) Appl. No.: 15/089,635

(22) Filed: Apr. 4, 2016

(30) Foreign Application Priority Data
Oct. 8, 2015 (JP) 2015-199873

(51) Int. Cl. G06K 9/00; H04N 13/02; B60R 1/00; H04N 7/18; G06T 7/00; B60Q 9/00

(52) U.S. Cl. CPC G06K 9/00805; G06T 7/004; B60Q 9/008; B60R 1/00; H04N 7/181; H04N 13/0203; B60T 2201/022; G06T 2207/10028; G06T 2207/30261; B60R 2300/8093; B60R 2300/8053

(57) ABSTRACT

This invention provides a driving assistance system for a vehicle, with which an intersection having poor visibility can be detected with a high degree of precision and a driver can be alerted thereto while suppressing cost and time requirements. A sample determination unit identifies an image captured by a front camera as detection subject sample data relating to an intersection having poor visibility when the detection subject is detected by a stereo camera, a distance calculation unit, and a first object detection unit but the detection subject is not detected in a position of the detected detection subject by the front camera and a second object detection unit, and identifies the image captured by the front camera as non-detection subject sample data when the detection subject is detected in the position of the detected detection subject by the front camera and the second object detection unit.

### BACKGROUND OF THE INVENTION

1. Field of the Invention

This invention relates to a driving assistance system and a driving assistance method for a vehicle, with which to learn intersections having poor visibility and alert a driver thereto.

2. Description of the Related Art

Techniques for forestalling accidents by detecting pedestrians, bicycles, motorcycles, and the like on a road from an image captured by a camera installed in a vehicle such as a four-wheeled vehicle and alerting a driver thereto have been developed in recent years.

In another conventional technique, meanwhile, a pedestrian or the like is detected at an intersection having poor visibility, where detection cannot be performed easily using the camera installed in the vehicle. More specifically, a conventional navigation apparatus for a vehicle alerts a driver by issuing a warning sound and displaying a warning image on a screen of a display unit after confirming that a host vehicle is approaching an intersection where a large number of accidents occur due to poor visibility caused by the existence of a large number of buildings (see Japanese Patent Application Publication No. H4-44087, for example).

Further, a conventional broadside collision prevention assistance system prevents broadside collisions when entering a priority road from a non-priority road by obtaining positions and speeds of vehicles traveling on the priority road from an infrastructure facility disposed on the roadside and notifying a driver of the obtained information. In so doing, useful vehicle information that cannot be detected by the host vehicle alone is acquired from the infrastructure facility in accordance with road shapes and positional relationships (see Japanese Patent Application Publication No. 2002-163789, for example).

However, the following problems occur in the prior art.

In the navigation system for a vehicle described in Japanese Patent Application Publication No. H4-44087, a determination as to whether or not the host vehicle is approaching an intersection having poor visibility is made on the basis of a current position of the host vehicle and map data, and therefore the driver is also alerted to intersections that in actuality have good visibility.

Further, in the broadside collision prevention assistance system described in Japanese Patent Application Publication No. 2002-163789, the infrastructure facility must be disposed at a large number of small-scale intersections, and therefore disposing the infrastructure facility is expensive and time-consuming.

### SUMMARY OF THE INVENTION

This invention has been designed to solve the problems described above, and an object thereof is to obtain a driving assistance system and a driving assistance method for a vehicle, with which an intersection having poor visibility can be detected with a high degree of precision and a driver can be alerted thereto while suppressing cost and time requirements.

A driving assistance system for a vehicle according to this invention includes a stereo camera that captures an image of a view of a rear of the vehicle, a distance calculation unit that calculates a distance to a detection subject captured by the stereo camera, a first object detection unit that detects a direction of the detection subject captured by the stereo camera, a high-precision positioning unit that measures coordinates of the vehicle, a front camera that captures an image of a view of a front of the vehicle, a second object detection unit that detects a direction of the detection subject captured by the front camera, and a sample determination unit that identifies the image captured by the front camera as detection subject sample data relating to an intersection having poor visibility when the detection subject is detected by the stereo camera, the distance calculation unit, and the first object detection unit but the detection subject is not detected in a position of the detected detection subject by the front camera and the second object detection unit, and identifies the image captured by the front camera as non-detection subject sample data when the detection subject is detected by the stereo camera, the distance calculation unit and the first object detection unit, and the detection subject is detected in the position of the detected detection subject by the front camera and the second object detection unit.

Further, a driving assistance method for a vehicle according to this invention is executed by a driving assistance system for a vehicle including a stereo camera that captures an image of a view of a rear of the vehicle, a distance calculation unit that calculates a distance to a detection subject captured by the stereo camera, a first object detection unit that detects a direction of the detection subject captured by the stereo camera, a high-precision positioning unit that measures coordinates of the vehicle, a front camera that captures an image of a view of a front of the vehicle, and a second object detection unit that detects a direction of the detection subject captured by the front camera, the method including: identifying the image captured by the front camera as detection subject sample data relating to an intersection having poor visibility when the detection subject is detected by the stereo camera, the distance calculation unit, and the first object detection unit but the detection subject is not detected in a position of the detected detection subject by the front camera and the second object detection unit; and identifying the image captured by the front camera as non-detection subject sample data when the detection subject is detected by the stereo camera, the distance calculation unit, and the first object detection unit and the detection subject is detected in the position of the detected detection subject by the front camera and the second object detection unit.

With the driving assistance system for a vehicle according to this invention, when the detection subject is detected by the stereo camera, the distance calculation unit, and the first object detection unit but the detection subject is not detected in the position of the detected detection subject by the front camera and the second object detection unit, the sample determination unit identifies the image captured by the front camera as detection subject sample data relating to an intersection having poor visibility, and when the detection subject is detected in the position of the detected detection subject by the front camera and the second object detection unit, the sample determination unit identifies the image captured by the front camera as non-detection subject sample data.

As a result, an intersection having poor visibility can be detected with a high degree of precision, and a driver can be alerted thereto, while suppressing cost and time requirements.

### BRIEF DESCRIPTION OF THE DRAWINGS

FIG. 1 is a block diagram showing a configuration of the driving assistance system for a vehicle during learning, according to a first embodiment of this invention.

FIG. 2 is an illustrative view illustrating learning processing implemented in the driving assistance system for a vehicle according to the first embodiment of this invention.

FIG. 3 is an illustrative view illustrating the learning processing implemented in the driving assistance system for a vehicle according to the first embodiment of this invention.

FIG. 4 is a block diagram showing the configuration of the driving assistance system for a vehicle during an operation, according to the first embodiment of this invention.

### DETAILED DESCRIPTION OF THE PREFERRED EMBODIMENTS

A preferred embodiment of a driving assistance system and a driving assistance method for a vehicle according to this invention will be described below using the drawings. Identical or corresponding parts in the drawings will be described using identical reference symbols. Note that in the following embodiment, a pedestrian is cited as an example of a detection subject, but the invention is not limited thereto, and the detection subject may also be a bicycle, a motorcycle, and so on.

The driving assistance system for a vehicle according to this invention detects an image of an intersection having poor visibility, which has been learned in advance, from an image captured by a camera installed in the vehicle, and alerts a driver thereto. Here, the intersection having poor visibility is learned as follows.

First, when a pedestrian detection unit of a leading vehicle among two vehicles constituted by a leading vehicle and a following vehicle detects a pedestrian at certain global coordinates but the pedestrian detection unit of the following vehicle does not detect the pedestrian in the same coordinate direction, an image obtained by the following vehicle in the coordinate direction is learned as an intersection having poor visibility.

Next, when a similar image to that of the learned intersection having poor visibility is detected by the vehicle during actual travel, the driver is alerted thereto. At this time, a conventional pedestrian detection apparatus such as a frontward monitoring camera image recognition apparatus installed in the vehicle, for example, can be applied as the driving assistance system for a vehicle according to this invention by switching the detection subject thereof from a pedestrian to an intersection having poor visibility.

### First Embodiment

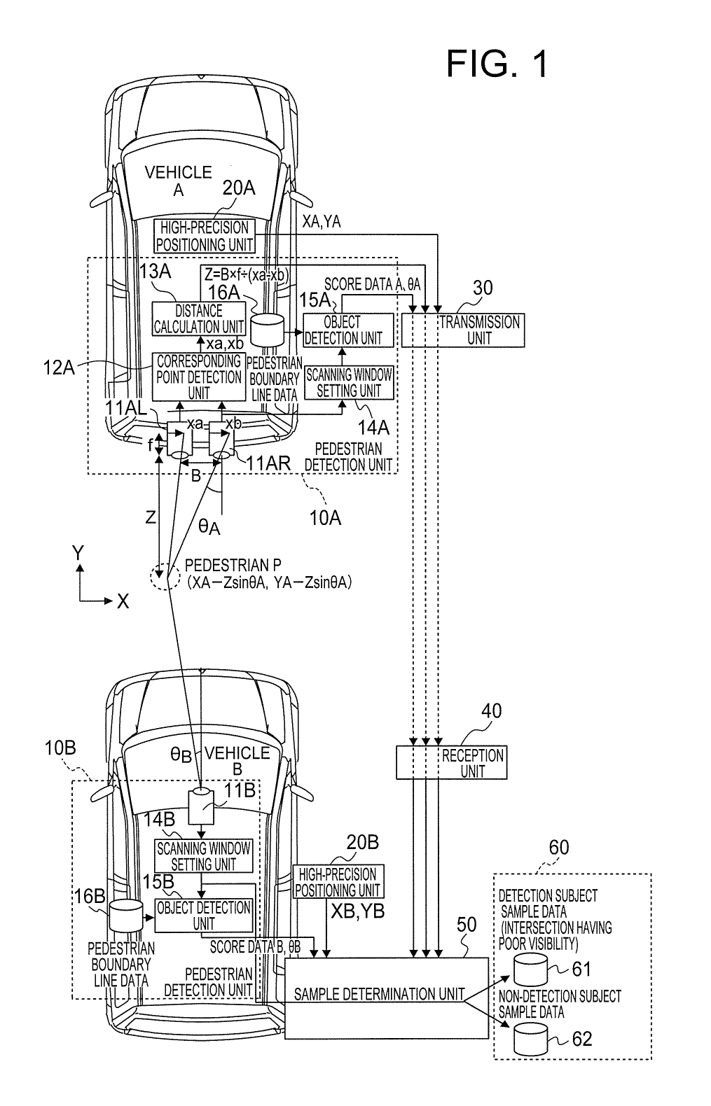

FIG. 1 is a block diagram showing a configuration of the driving assistance system for a vehicle during learning, according to a first embodiment of this invention. In FIG. 1, a leading vehicle A includes a pedestrian detection unit 10A, a high-precision positioning unit 20A, and a transmission unit 30.

Further, the pedestrian detection unit 10A includes cameras 11AR, 11AL constituting a stereo camera, a corresponding point detection unit 12A, a distance measurement unit 13A, a scanning window setting unit 14A, an object detection unit 15A, and pedestrian boundary line data 16A. An image of the view of the rear of the vehicle is captured by the cameras 11AR, 11AL, a pedestrian P is detected from the image, and score data A indicating a distance Z to the pedestrian P, a direction θA of the pedestrian, and a pedestrian resemblance are output.

Further, the corresponding point detection unit 12A detects a point xa of the camera 11AL onto which the pedestrian P is projected having been projected onto a point xb of the camera 11AR. Furthermore, the distance calculation unit 13A calculates the distance Z to the pedestrian P serving as the detection subject on the basis of the point xa, the point xb, a focal length f of the cameras 11AR, 11AL, and an interval B between the camera 11AR the camera 11AL using a following equation. A method of calculating the distance Z is specifically described in, for example, Japanese Patent Application Publication No. 2009-104366.

Z(=B×f/(xa−xb))

Note that in order to recognize the pedestrian accurately, an object detection apparatus for detecting a detection subject, such as that disclosed in Japanese Patent Application Publication No. 2011-198006, for example, is used. This detection apparatus is constituted by a scanning window setting unit that sets a scanning window on an image input from a camera, and an object detection unit that extracts an HOG (Histogram of Oriented Gradient) feature quantity or the like from the set scanning window and outputs a score expressing a detection subject resemblance.

The object detection unit extracts, in advance, feature quantities from a detection subject sample constituted by an image of a person and a non-detection subject sample constituted by an image of an object other than a person or an image not including any objects, and then learns and constructs a boundary line between the detection subject sample and the non-detection subject sample in a resulting feature quantity space on the basis of a distribution of learned samples, or in other words detection subject samples and non-detection subject samples, in the feature quantity space using a representative statistical learning method such as SVM (Support Vector Machine) or boosting.

Furthermore, the object detection unit outputs the detection subject resemblance of the object in the scanning window as a score on the basis of a spatial position relationship between the feature quantity extracted from the scanning window and the boundary line in the feature quantity space constructed in advance.

For this purpose, the scanning window setting unit 14A shown in FIG. 1, similarly to Japanese Patent Application Publication No. 2011-198006, sets a scanning window in a partial region of an image input from the camera 11AR or the camera 11AL.

Further, the object detection unit 15A outputs the score data A expressing the pedestrian resemblance in the scanning window and the direction θA of the scanning window at that time on the basis of a positional relationship between the feature quantity of the scanning window and a boundary line of a feature quantity space constructed in advance and expressed by the pedestrian boundary line data 16A.

The high-precision positioning unit 20A is a satellite positioning system that uses a semi-zenith satellite disclosed in Japanese Patent Application Publication No. 2004-62874, for example, a GPS (Global Positioning System) satellite, or the like to measure the global position of the vehicle A in the form of coordinates (XA, YA).

The transmission unit 30 transmits the distance Z to the pedestrian P, output by the distance measurement unit 13A, the score data A and the direction θA, output by the object detection unit 15A, and the coordinates (XA, YA), output by the high-precision positioning unit 20A, wirelessly to the following vehicle B.

Moreover, in FIG. 1, the following vehicle B includes a pedestrian detection unit 10B, a high-precision positioning unit 20B, a reception unit 40, a sample determination unit 50, and sample data 60. Further, the pedestrian detection unit 10B includes a camera 11B, a scanning window setting unit 14B, an object detection unit 15B, and pedestrian boundary line data 16B.

The camera 11B captures an image of the view of the front of the vehicle. The scanning window setting unit 14B sets a scanning window in a partial region of the image input from the camera 11B.

Further, the object detection unit 15B outputs score data B expressing the pedestrian resemblance in the scanning window and a direction θB of the scanning window at that time on the basis of a positional relationship between a feature quantity of the scanning window and a boundary line of a feature quantity space constructed in advance and expressed by the pedestrian boundary line data 16B.

The high-precision positioning unit 20B, similarly to the high-precision positioning unit 20A, measures the global position of the vehicle B in the form of coordinates (XB, YB). The reception unit 40 receives the distance Z to the pedestrian P, the score data A and the direction θA, and the coordinates (XA, YA) from the transmission unit 30.

The sample determination unit 50 identifies image data in the scanning window set by the scanning window setting unit 14B as either detection subject sample data 61 or non-detection subject sample data 62 on the basis of the score data B and the direction θB output by the object detection unit 15B, the coordinates (XB, YB) output by the high-precision positioning unit 20B, and the distance Z to the pedestrian P, the score data A, the direction θA, and the coordinates (XA, YA) received by the reception unit, and then stores the image data as the sample data 60.

In the vehicle A and the vehicle B configured as described above, first, the detection subject sample data 61 and the non-detection subject sample data 62 are gathered in relation to an intersection having poor visibility. At this time, the vehicle A leads and the vehicle B follows the vehicle A at a fixed distance.

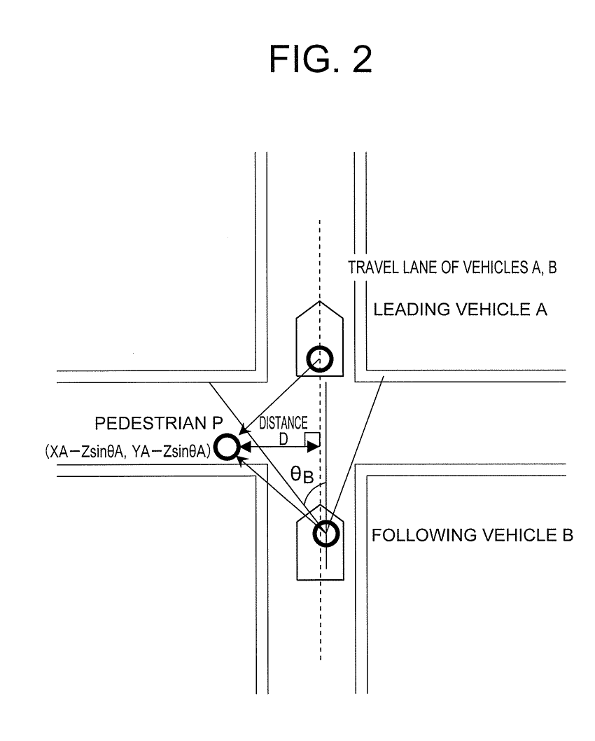

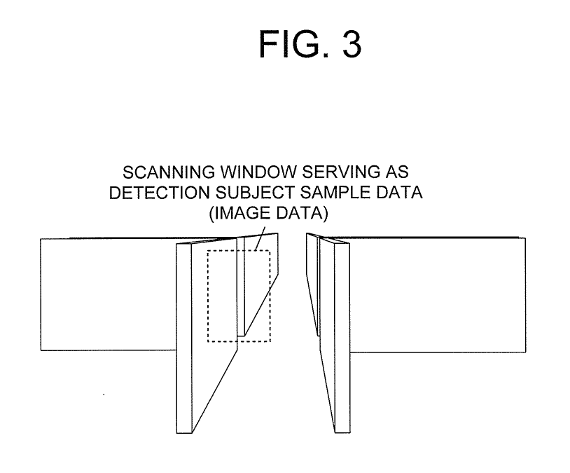

As shown in FIG. 2, when, at an intersection having poor visibility, the pedestrian detection unit 10A of the vehicle A detects the pedestrian P at coordinates (XA−ZsinθA, YA−ZsinθA) but the pedestrian detection unit 10B of the vehicle B does not detect the pedestrian P in the direction θB, the sample determination unit 50 of the vehicle B determines that the intersection is an intersection having poor visibility, and identifies the image data of a scanning window shown in FIG. 3, for example, as the detection subject sample data 61. Note that the direction θB is expressed by a following equation using the direction θA. Further, here, the detection subject is an intersection having poor visibility.

$$θ B = {tan}^{- 1} ( \frac{XB - XA + Z cos {θ}_{A}}{YA - Z cos {θ}_{A} - YB} )$$

When, on the other hand, the pedestrian detection unit 10B of the vehicle B also detects the pedestrian P detected by the pedestrian detection unit 10A of the vehicle A, the sample determination unit 50 of the vehicle B determines that the intersection is not an intersection having poor visibility, and identifies the image data of the scanning window set at this time as the non-detection subject sample data 62.

Note, however, that when the pedestrian is closer to a travel lane of the vehicle A and the vehicle B than a fixed distance range, the pedestrian is assumed to be walking along the edge of the road, and therefore the sample determination unit 50 of the vehicle B does not perform the identification operation. Here, the fixed distance is preferably set at approximately a minimum value of a distance between the travel lane of the vehicle A and the vehicle B and the pedestrian in a case where the intersection is determined to be an intersection having poor visibility, or in other words approximately a distance D shown in FIG. 3.

Note that in the above description, learning is performed while the vehicle A and the vehicle B travel, but this invention is not limited thereto, and images from the cameras installed respectively in the vehicle A and the vehicle B may be stored together with the position information obtained by the high-precision positioning units so that the detection subject sample data 61 and the non-detection subject sample data 62 can be identified following the end of travel.

Furthermore, in the above description, the vehicle A and the vehicle B are constituted by separate vehicles, but this invention is not limited thereto, and the apparatus of the vehicle B may be installed in the vehicle A so that the detection subject sample data 61 and the non-detection subject sample data 62 are identified using stored data obtained by the camera when the vehicle A is in a position corresponding to the position of the vehicle B.

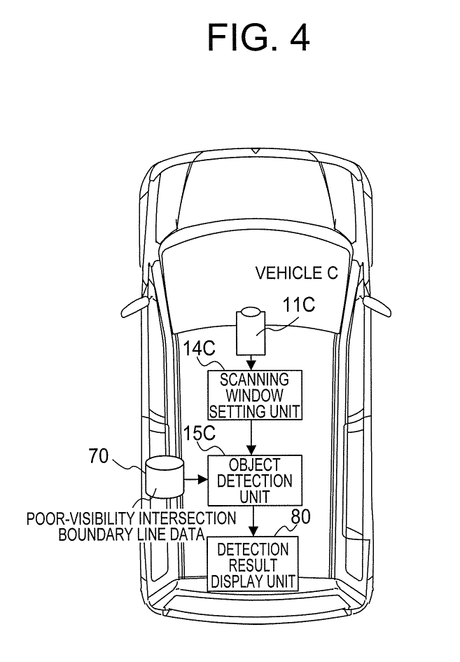

FIG. 4 is a block diagram showing the configuration of the driving assistance system for a vehicle during an operation, according to the first embodiment of this invention. In FIG. 4, a vehicle C includes a camera 11C, a scanning window setting unit 14C, an object detection unit 15C, poor-visibility intersection boundary line data 70, and a detection result display unit 80, and is configured to detect an intersection having poor visibility.

The camera 11C captures an image of the view of the front of the vehicle. The scanning window setting unit 14C sets a scanning window in a partial region of the image input from the camera 11C.

Further, the object detection unit 15C outputs score data C expressing a poor-visibility intersection resemblance in the scanning window and a direction θC of the scanning window at that time on the basis of a positional relationship between a feature quantity of the scanning window and a boundary line of a feature quantity space expressed by the poor-visibility intersection boundary line data 70.

Here, the poor-visibility intersection boundary line data 70 indicate a boundary line of an intersection having poor visibility in a feature quantity space constructed in advance from image data obtained from the scanning window and identified as either the detection subject sample data 61 or the non-detection subject sample data 62 shown in FIG. 1. The detection result display unit 80 displays a detection result of the intersection having poor visibility on the basis of the score data C output by the object detection unit 15C, and if necessary, alerts the driver thereto.

In other words, an actual system operation is performed in the vehicle C. The object detection unit 15C of the vehicle C detects an intersection having poor visibility using the poor-visibility intersection boundary line data 70 constructed from the detection subject sample data 61 and the non-detection subject sample data 62. When an intersection having poor visibility is detected at this time, the detection result display unit 80 of the vehicle C alerts the driver to the intersection having poor visibility, and prompts the driver to perform an operation such as approaching the intersection having poor visibility at reduced speed.

Hence, according to this driving assistance system for a vehicle, an intersection having poor visibility can be detected simply by switching the detection subject boundary line data in a conventional pedestrian detection apparatus. As a result, an intersection having poor visibility can be detected, and a driver can be alerted thereto, by the driving assistance system for a vehicle without the need for infrastructure facilities.

According to the first embodiment, as described above, when a detection subject is detected by the stereo camera, the distance calculation unit, and the first object detection unit but the detection subject is not detected in the position of the detected detection subject by the front camera and the second object detection unit, the sample determination unit identifies the image captured by the front camera as detection subject sample data relating to an intersection having poor visibility, and when the detection subject is detected in the position of the detected detection subject by the front camera and the second object detection unit, the sample determination unit identifies the image captured by the front camera as non-detection subject sample data. As a result, an intersection having poor visibility can be detected with a high degree of precision, and a driver can be alerted thereto, while suppressing cost and time requirements.

What is claimed is:

1. A driving assistance system for a vehicle, comprising:
a stereo camera that captures an image of a view of a rear of the vehicle;
a distance calculator that calculates a distance to a detection subject captured by the stereo camera;
a first object detector that detects a direction of the detection subject captured by the stereo camera;
a high-precision indicator that measures coordinates of the vehicle;
a front camera that captures an image of a view of a front of the vehicle;
a second object detector that detects a direction of the detection subject captured by the front camera; and
a sample determiner that identifies the image captured by the front camera as detection subject sample data relating to an intersection having poor visibility when the detection subject is detected by the stereo camera, the distance calculator, and the first object detector but the detection subject is not detected in a position of the detected detection subject by the front camera and the second object detector, and
identifies the image captured by the front camera as non-detection subject sample data when the detection subject is detected by the stereo camera, the distance calculator, and the first object detector and the detection subject is detected in the position of the detected detection subject by the front camera and the second object detector.

2. The driving assistance system for a vehicle according to claim 1, wherein the stereo camera, the distance calculator, and the first object detector are provided in a leading vehicle, and
the front camera and the second object detector are provided in a following vehicle.

3. The driving assistance system for a vehicle according to claim 2, wherein the sample determiner does not perform an identification operation when the detection subject is closer to a travel lane of the leading vehicle and the following vehicle than a fixed distance range.

4. The driving assistance system for a vehicle according to claim 1, wherein the stereo camera, the distance calculator, the first object detector, the front camera, and the second object detector are provided in a single vehicle.

5. A driving assistance system for a vehicle, comprising: poor-visibility intersection boundary line data constructed from the detection subject sample data and the non-detection subject sample data according to claim 1;
a third object detector that detects an intersection having poor visibility by applying the poor-visibility intersection boundary line data to the image of the view of the front of the vehicle; and
a detection result display that alerts a driver of the vehicle in accordance with a detection result obtained by the third object detector.

6. A driving assistance method for a vehicle, executed by a driving assistance system for a vehicle including:
a stereo camera that captures an image of a view of a rear of the vehicle;
a distance calculator that calculates a distance to a detection subject captured by the stereo camera;
a first object detector that detects a direction of the detection subject captured by the stereo camera;
a high-precision indicator that measures coordinates of the vehicle;
a front camera that captures an image of a view of a front of the vehicle; and
a second object detector that detects a direction of the detection subject captured by the front camera,
the method comprising:
identifying the image captured by the front camera as detection subject sample data relating to an intersection having poor visibility when the detection subject is detected by the stereo camera, the distance calculator, and the first object detector but the detection subject is not detected in a position of the detected detection subject by the front camera and the second object detector; and
identifying the image captured by the front camera as non-detection subject sample data when the detection subject is detected by the stereo camera, the distance calculator, and the first object detector and the detection subject is detected in the position of the detected detection subject by the front camera and the second object detector.
